(19) United States
(12) Patent Application Publication
(10) Pub. No.: US 2012/0148899 A1
(43) Pub. Date: Jun. 14, 2012

(54) ELECTROCHEMICAL CELL HAVING A SEPARATOR

(75) Inventors: Andreas Gutsch, Luedinghausen (DE); Tim Schaefer, Niedersachswerfen (DE)

(73) Assignee: LI-TEC BATTERY GMBH, Kamenz (DE)

(21) Appl. No.: 13/319,698

(22) PCT Filed: Apr. 29, 2010
(86) PCT No.: PCT/EP2010/002638

§ 371 Date: Feb. 28, 2012

(30) Foreign Application Priority Data
May 14, 2009 (DE) 10 2009 021 230.2

(51) Int. Cl. H01M 2/16; H01M 6/02; B82Y 30/00

(52) U.S. Cl. 429/144; 29/623.5; 977/773

(57) ABSTRACT

Electrochemical cell comprising a positive and a negative elecrode and a layer of an inorganic substance arranged between the electrodes, characterized in that the layer is coated with a polyetherimide on one or both sides.

The present invention relates to an electrochemical cell comprising a positive electrode and a negative electrode and a separator in between comprising an inorganic substance. Additional subjects of the invention relate to a method for producing the cell and the separator contained in the electrochemical cell.

So-called “high-power batteries” are preferably used in electric tools and vehicles having a hybrid drive.

The separators used in such batteries to separate the negative electrode from the positive electrode should be designed to permit easy passage of charge carriers through the separator. This is one of the prerequisites for producing an amperage that is high enough. This goal is achieved in general by designing the separators to be relatively thin, i.e., in the form of membranes, so that charge transport through the membranes can be accomplished easily enough. Typical thicknesses of the membranes are in the range of 50 μm. Commercial products include membranes based on polypropylene or polyether, for example. Commercial products are known by such names as Celgard®, Setala®, Hipore® or Exepol®, for example.

On the other hand, the thickness of the separators must not be so small that the mechanical strength suffers as a result or even that there is an uncontrolled flow of charge carriers, resulting in short-circuiting of the battery. Furthermore, separators should also effectively prevent any possible “meltdown” or “breakdown” of an electrochemical cell, as they are commonly known in the technical area and which can not only result in destruction of the cell, but can also endanger the user.

Lithium ion batteries are high-power batteries, for example. In such batteries, lithium ions, as charge carriers, migrate through the separator.

It was an object of the present invention to provide an electrochemical cell, in particular an electrochemical cell with lithium ions, comprising a separator which allows sufficiently easy passage of the charge carriers without negative effect on the mechanical strength of the cell, respectively, without increasing the risk of a short circuit, and which will effectively counteract a possible “meltdown” or “breakdown” of the batteries.

This object has been achieved with an electrochemical cell comprising a positive electrode and a negative electrode and a layer of an inorganic substance arranged between the electrodes, characterized in that the layer is coated with a polyetherimide on one or both sides.

The layer of the inorganic substance of the electrochemical cell consequently has the function of a separator which separates the negative electrode from the positive electrode.

The term “a layer” also comprises a plurality of layers of one or more inorganic substances which may be the equal or different from each other.

The term “negative electrode” refers to the electrode which releases electrons when connected to the consumer, for example, an electric motor. The negative electrode is thus the anode. The term “positive electrode” refers to the electrode that receives electrons when connected to the consumer, e.g. the electric motor. The positive electrode is thus the cathode.

In a preferred embodiment, the electrochemical cell is characterized in that the negative electrode or the positive electrode or the negative electrode and the positive electrode contain lithium.

The positive electrode may preferably be designed in a known way, based on lithium mixed oxides, such as lithium cobalt oxide, lithium manganese oxide or lithium iron phosphate and/or mixed oxides based on nickel, manganese and cobalt. The negative electrode is preferably based on carbon or lithium titanate.

The substances defined above for the electrode are preferably applied on substances, which preferably comprise aluminum or copper or are made of aluminum or copper.

These electrodes as well as the separator are preferably realized as a film. This means that both the electrodes and the separator are realized in the form of a layer or in the form of layers of the corresponding materials or substances.

The prerequisite for achieving an adequate amperage for the separator is that it must be ionically conductive which means that the separator comprises a porous structure. In case of an electrochemical cell which operates with lithium ions, the separator must allow lithium ions to pass through the separator.

In a preferred embodiment, the layer of the inorganic substance comprises a metal oxide.

In a preferred embodiment, the inorganic substance comprises, in addition to the polyetherimide layer, a substrate, which is coated with the inorganic substance on at least one side. The substrate used comprises an organic material which is preferably embodied as a nonwoven fabrics. The organic material preferably comprises a polyethylene glycol terephthalate (PET), a polyolefin (PO) or a polyetherimide (PEI). The inorganic substance is ionically conductive in a temperature range from −40° C. to 200° C. The inorganic ionically conductive substance is preferably at least one compound selected from the group of oxides, phosphates, sulfates, titanates, silicates, aluminosilicates of at least one of the elements Zr, Al, Li, in particular zirconium oxide. The inorganic substance preferably comprises particles having a maximum diameter of less than 100 nm.

The term “material” comprises a substance having a defined geometry, e.g., in the form of a film.

In a particularly preferred embodiment, said organic material is a polyethylene glycol terephthalate.

A separator of this type is known from WO 99/62620 and respectively can be produced by the methods disclosed therein. Such a separator is also available commercially under the brand name Separion®.

According to the invention this separator which is present in the form of a composite of the organic substrate with the inorganic substance is preferably a layered composite in film form, coated on one or both sides with the polyetherimide in the electrochemical cell according to the invention.

In another embodiment, the separator comprises the inorganic substance which is ionically conductive in a temperature range from −40° C. to 200° C., and whereas the inorganic substance is coated with the polyetherimide on one or both sides.

In this embodiment, all oxides of magnesium, calcium, aluminum, silicon and titanium are preferably used as the inorganic substance, as well as silicates and zeolites, borates and phosphates. Such substances for separators as well as methods for producing the separators are disclosed in EP 1 783 852.

In a preferred embodiment of this embodiment of a separator, the separator comprises a layer of magnesium oxide coated with the polyetherimide on one or both sides.

In another embodiment, 50 to 80 wt % of the magnesium oxide may be substituted by calcium oxide, barium oxide, barium carbonate, lithium phosphate, sodium phosphate, potassium phosphate, magnesium phosphate, calcium phosphate, barium phosphate or by lithium borate, sodium borate, potassium borate or mixtures of these compounds.

The polyetherimide which is coated on one or both sides with the layer of the inorganic substance is preferably in the form of nonwoven fabrics in the separator. The term “nonwoven fabrics” means that the fibers are present in a nonwoven form (nonwoven fabrics). Such nonwoven fabrics are known in the prior art and/or can be produced by known methods, for example, by a spunbonding method or a melt-blowing method, as described in DE 195 01 271 A1.

Polyetherimides are known polymers and/or can be produced by known methods. Such methods are disclosed in EP 0 926 201, for example.

Polyetherimides are available commercially under the brand name Ultem®, for example.

According to the invention, said polyetherimide may be present in one layer or in multiple layers in the separator, each coated on one and/or both sides on the layer of the inorganic material.

In a preferred embodiment, the polyetherimide comprises an additional polymer.

These polymers are preferably selected from the group consisting of polyester, polyolefin, polyacrylonitrile, polycarbonate, polysulfone, polyether sulfone, polyvinylidene fluoride, polystyrene.

The additional polymer is preferably a polyolefin.

Preferred polyolefins are polyethylene and polypropylene.

The polyetherimide, preferably in form of the nonwoven fabrics, is preferably coated with one or more layers of the additional polymer, preferably the polyolefin which is preferably also in the form of nonwoven fabrics.

The coating of the polyetherimide with the additional polymer, preferably the olefin, may be accomplished by adhesive bonding, lamination, chemical reaction, welding or by a mechanical joining. Such polymer composites as well as methods of producing the same are known from EP 1 852 926.

The nonwoven fabrics are preferably prepared from nanofibers of the polymers used, forming nonwoven fabrics comprising a high porosity but small pore diameters. The risk of short-circuit reactions can be further reduced by this way.

The fiber diameter of the polyetherimide nonwoven fabrics is preferably larger than the fiber diameter of the additional polymer nonwoven fabrics, preferably the polyolefin nonwoven fabrics.

The nonwoven fabrics produced from polyetherimide preferably then has a higher pore diameter than the nonwoven fabrics produced from the additional polymer.

The use of a polyolefin in addition to the polyetherimide ensures an increased safety of the electrochemical cell because if there is unwanted or excessive heating of the cell, the pores of the polyolefin will contract and the charge transport through the separator is reduced or terminated. If the temperature of the electrochemical cell increases to such an extent that the polyolefin starts to melt, the polyetherimide, which is very stable with respect to the effects of temperature, will counteract the meltdown of the separator and will thus prevent uncontrolled destruction of the electrochemical cell.

The ion-conducting ability of the separator can be further improved if a nonaqueous electrolyte is added such that the separator is impregnated with this electrolyte. The nonaqueous electrolyte preferably comprises an organic solvent and lithium ions.

The organic solvent is preferably selected from ethylene carbonate, propylene carbonate, diethyl carbonate, dipropyl carbonate, 1,2-dimethoxyethane, γ-butyrolactone, tetrahydrofurane, 2-methyltetrahydrofurane, 1,3-dioxolane, sulfolane, acetonitrile or phosphoric acid esters or mixtures of these solvents.

The lithium ions which are present in the electrolyte preferably comprise one or more counterions selected from AsF₆⁻, PF₆⁻, PF₃(C₂F₅)₃⁻, PF₃(CF₃)₃⁻, BF₄⁻, BF₂(CF₃)₂⁻, BF₃(CF₃)⁻, [(B)COOCOO)₂]⁻, CF₃SO₃⁻, C₄F₉SO₃⁻, [(CF₃SO₂)₂N]⁻, [(C₂F₅SO₂)₂N]⁻, [(CN)₂N]⁻, ClO₄⁻.

Addition of the electrolyte to the separator may already be accomplished at the time of production of the separator, for example, according to methods such as those disclosed in EP 1 783 852, where the electrolyte and the educts or substances that are needed for producing the separator are combined and then the separator containing the electrolyte is produced. It is of course also possible to first produce the separator and then impregnate it subsequently with the electrolyte.

The layer of the inorganic substance, which is used for the separator, can be coated with polyetherimide by traditional methods.

If an inorganic substance containing an organic substrate is used as the basis of the separator, i.e., preferably a Separion® type, then the polyetherimide is preferably laminated with this material, preferably under the influence of pressure and/or temperature, more preferably by co-extrusion with the Separion® type or by adhesive bonding.

If an inorganic substance is used as the basis for the separator of the electrochemical cell according to the invention, i.e., an inorganic substance which does not contain any substrate, then the polyetherimide is preferably coated with this inorganic substance. This coating is preferably performed in such a way that a dispersion of the inorganic substance is applied to the polyetherimide. The inorganic substance is preferably applied to the polyetherimide as particles having a grain size of approximately 5-40 μm in the form of a preferably nonaqueous dispersion. The resulting dispersion film may then be dried or processed further as described below, if necessary.

To produce the electrochemical cell according to the invention, methods which are known in principle, for example, the methods described in “Handbook of Batteries,” Third Edition, McGraw-Hill, Editors: D. Linden, T. B. Reddy, 35.7.1″ may be used.

In one embodiment, the layer of the inorganic substance is formed directly on the negative or positive electrode or the negative and positive electrode.

The inorganic substance is preferably applied as a paste or dispersion directly to the negative electrode and/or to the positive electrode. By co-extrusion, a laminated composite is then formed. Such methods are disclosed in EP 1 783 852, for example.

The terms “paste” and “dispersion” are used synonymously.

The laminated composite then comprises an electrode and the separator and/or both electrodes and the separator in between them.

After extrusion the resulting composite can be dried and/or sintered by usual methods, if necessary.

It is also possible to produce the negative electrode and the positive electrode as well as the layer of the inorganic substance, i.e., the separator, separately from each other. The inorganic substance is then preferably embodied as a film. The separately produced electrodes and the separator are then supplied continuously and separately to a processing unit where the negative electrode is combined with the separator and the positive electrode and laminated to form a cell composite. The processing unit preferably comprises or consists of laminating rollers. Such a method is known from WO 01/82403.

The resulting composite is then preferably wound on a winding machine, forming a wound cell.

It is also possible to provide at least one of the electrodes, preferably both electrodes, respectively the educt mixtures from which the negative electrode and the positive electrode are produced and to laminate them with the substances respectively materials that are used to produce the separator.

The positive electrode or the negative electrode or the positive electrode and the negative electrode may preferably be coated with the inorganic substance which is comprised by the separator with or without the carrier material, depending on the embodiment. Subsequently, a coextrusion with the polyetherimide, which is preferably provided in form of nonwoven fabrics, is conducted. In a preferred embodiment, the polyetherimide is coated with a polyolefin.

Accordingly the present invention also relates to a method for producing the electrochemical cell according to the invention which is characterized in that the positive electrode or the negative electrode or the positive and the negative electrode are coated with the inorganic substance.

In one embodiment the inorganic substance is present as a film.

One embodiment of the method is characterized in that the positive or the negative electrode or the positive and the negative electrode and the substances or materials used to produce the separator are laminated together.

In one embodiment, the lamination is performed by paste extrusion.

Another subject of the invention is a separator comprising an inorganic substance for an electrochemical cell, preferably for the electrochemical cell according to the invention, characterized in that the separator is coated on one or both sides with a polyetherimide.

The separator preferably comprises the embodiments defined above, i.e., the layer of the inorganic substance coated with polyetherimide. wherein this may comprise an organic substrate or it may also be present without the organic substrate.

Another subject of the invention is a method for producing the separator according to the invention, which is characterized in that a layer of the inorganic substance is coated with a polyetherimide on one or both sides.

### EXAMPLES

### Example 1

a) Electrostatic polyetherimide fibers with an average fiber diameter of approximately 2 μm are spun from dimethylformamide and then processed to form a nonwoven fabric having a thickness of approximately 30 μm.

b) 25 parts by weight LiPF₆ and 20 parts by weight ethylene carbonate, 10 parts by weight propylene carbonate, 25 parts by weight magnesium oxide and 5 g Kynar 2801®, a binder, are mixed together and dispersed in a disperser until a homogeneous dispersion is formed.

c) A dispersion prepared according to b) is applied to the nonwoven fabric produced according to a), so that the applied layer has a thickness of approximately 40 μm.

d) A composition of a mixture of 75 parts by weight MCMB 25/28® mesocarbon microbeads (Osaka Gas Chemicals), 10 parts by weight lithium oxalatoborate, 8 parts by weight Kynar 2801® and 7 parts by weight propylene carbonate is applied by means of an extruder to an aluminum foil being 18 μm thick, resulting in a layer thickness of the applied layer of approximately 40 μm.

e) A composition of a mixture of 75 parts by weight lithium cobalt oxide, 5 parts by weight lithium borate, 10 parts by weight Kynar 2801® and 10 parts by weight propylene carbonate is applied using an extruder to an aluminum foil having a thickness of 18 μm and having a primer layer (3 μm thick), consisting of a fluorinated terpolymer (Dyneon THV 220 D®) and 30 parts by weight conductive carbon black (Ensaco®) (wt % based on the solid content of the fluorinated terpolymer), resulting in a layer thickness of approximately 40 μm.

f) The products produced according to c), d) and e) are wound on a winding machine such that the product according to c) is arranged between the coatings of the products according to d) and e) such that the polyetherimide nonwoven fabrics is in contact with the coating of the product according to Example 1 e). The metal foils are provided with tabs and the system is enclosed in heat-shrinkage film.

### Example 2

a) The nonwoven fabrics produced according to Example 1 a) is adhered to a polypropylene nonwoven fabrics produced by an analog method and having an average fiber diameter of approximately 2 μm and a thickness of 30 μm, by ultrasonic welding.

b) The mixture produced according to Example 1 b) having a thickness of 30 μm is applied to the products produced according to Examples 1 d) and e).

c) The products produced according to Examples 2 a) and 2 b) are wound on a winding machine, such that the product according to 2 a) is arranged between the coatings of the products according to 2 b), such that the polyetherimide nonwoven fabrics contacts the coating of the product according to Example 1 e). The metal foils are provided with tabs, and the system is enclosed in a heat-shrinkage film.

1. Electrochemical cell comprising a positive electrode and a negative electrode and a layer of an inorganic substance arranged between the electrodes,
wherein
the layer is coated with a polyetherimide on one or both sides.

2. Electrochemical cell according to claim 1,
wherein
the negative electrode or the positive electrode or the negative electrode
and the positive electrode comprise lithium.

3. Electrochemical cell according to claim 2,
wherein
the inorganic substance comprises a metal oxide.

4. Electrochemical cell according to claim 3,
wherein
the layer additionally comprises a substrate which is coated on at least one side with the inorganic substance, wherein an organic material is embodied as a nonwoven fabrics is used as the substrate, wherein the organic material comprises a polyethylene glycol terephthalate, a polyolefin or a polyetherimide, wherein the the inorganic substance is ionically conductive in a temperature range from −40° C. to 200° C., wherein the inorganic substance comprises at least one compound selected from the group of oxides, phosphates, sulfates, titanates, silicates, aluminosilicates of at least one of the elements Zr, Al, Li, and wherein the inorganic substance comprises particles with a maximum diameter of less than 100 nm.

5. Electrochemical cell according to claim 3,
wherein
the inorganic substance comprises magnesium oxide.

6. Electrochemical cell according to claim 5,
wherein
the polyetherimide is coated with one or more layers of a polyolefin.

7. Electrochemical cell according to claim 6,
wherein
the polyetherimide or the polyolefin or the polyetherimide and the polyolefin are embodied in the form of nonwoven fabrics.

8. Electrochemical cell according to any one of the preceding claims claim 7,
wherein
the layer of the inorganic substance comprises a nonaqueous solvent and a lithium salt.

9. Electrochemical cell according to claim 8,
wherein
the layer of the inorganic substance is formed on the negative or positive electrode or the negative and the positive electrode.

10. A method for producing an electrochemical cell as defined in claim 9,
wherein
the positive or the negative electrode or the positive and the negative electrode are coated with the inorganic substance.

11. The method according to claim 10,
wherein
the inorganic substance is embodied in the form of a film.

12. The method according to claim 11,
wherein
the positive or the negative electrode or the positive and the negative electrode and the inorganic material are laminated together.

13. The method according to claim 12,
wherein
the lamination is performed by extrusion of a paste.

14. Separator for an electrochemical cell, comprising a layer of an inorganic substance,
wherein
the layer is coated with a polyetherimide on one or both sides.
